(19) United States
(12) Patent Application Publication
(10) Pub. No.: US 2011/0265434 A1
(43) Pub. Date: Nov. 3, 2011

(54) FILTER ASSEMBLY

(75) Inventors: Cynthia Marie Polizzi, Lee's Summit, MO (US); Taher Mousa Abujoudeh, Lee's Summit, MO (US)

(73) Assignee: GENERAL ELECTRIC COMPANY, Schenectady, NY (US)

(21) Appl. No.: 12/770,126

(22) Filed: Apr. 29, 2010

(51) Int. Cl. B01D 46/24; B01D 35/02

(52) U.S. Cl. 55/385.1; 55/492

(57) ABSTRACT

In an embodiment, a filter assembly includes: at least one airflow inlet; at least one tubular filter element adjacent to the at least one airflow inlet; and a support member attached to the at least one tubular filter element at a first portion and a second portion of the support member, the at least one tubular filter element circumferentially surrounding the support member, wherein the support member includes a composite material.

### BACKGROUND OF THE INVENTION

The present invention relates generally to a filter assembly, and more particularly to a filter assembly including a support member comprising composite material.

There are certain types of machines that require a clean airflow in order to operate properly and efficiently. One example of this type of machine is a gas turbine. During operation of a gas turbine, a compressor draws in air from the surrounding environment, compresses the air, and provides it to a combustion chamber. In the combustion chamber, the air is mixed with a supplied fuel that is ignited. This creates high temperature combustion gases that drive the gas turbine.

In order to increase efficiency, the air from the surrounding environment must be filtered to remove unwanted particles so that clean, filtered air is provided to the remaining portions of the gas turbine system. A plenum wall separates the clean, filtered air from the dirty, unfiltered air. Inlets are provided on the plenum wall and filter elements are mounted to surround the inlets. The air flows through the filter elements such that the unwanted particles are removed from the air.

### BRIEF DESCRIPTION OF THE INVENTION

A first aspect of the invention provides a filter assembly comprising: at least one airflow inlet; at least one tubular filter element adjacent to the at least one airflow inlet; and a support member attached to the at least one tubular filter element at a first portion and a second portion of the support member, the at least one tubular filter element circumferentially surrounding the support member, wherein the support member comprises a composite material.

A second aspect of the invention provides a system comprising: a gas turbine; and a filter assembly operably connected to the gas turbine, the filter assembly comprising: at least one airflow inlet; at least one tubular filter element adjacent to the at least one airflow inlet; and a support member attached to the at least one tubular filter element at a first portion and a second portion of the support member, the at least one tubular filter element circumferentially surrounding the support member, wherein the support member comprises a composite material.

A third aspect of the invention provides a system comprising: a gas turbine; a heat exchanger operably connected to the gas turbine; a steam turbine operably connected to the heat exchanger; and a filter assembly operably connected to the gas turbine, the filter assembly comprising: at least one airflow inlet; at least one tubular filter element adjacent to the at least one airflow inlet; and a support member attached to the at least one tubular filter element at a first portion and a second portion of the support member, the at least one tubular filter element circumferentially surrounding the support member, wherein the support member comprises a composite material.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a perspective view of a filter assembly according to an embodiment of the invention.

FIG. 2 shows a perspective view of a filter assembly according to an embodiment of the invention.

FIG. 3 shows a perspective view of a filter assembly according to an embodiment of the invention.

FIG. 4 shows a schematic view of a system according to an embodiment of the invention.

FIG. 5 shows a schematic view of a combined-cycle system according to an embodiment of the invention.

FIG. 6 shows a schematic view of a combined-cycle system according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

In a filter assembly, support structures are often provided at the airflow inlet to support and guide a filter element to ensure an air-tight seal along the filter element and the plenum wall interface. This is to guarantee that dirty, unfiltered air does not bypass the filter element and contaminate the clean air. Often, this support structure takes shape as a tripod. However, conventional support structures, such as tripods, are often made of steel, which will quickly corrode over time, especially in applications where moist or humid salt-laden air is being filtered.

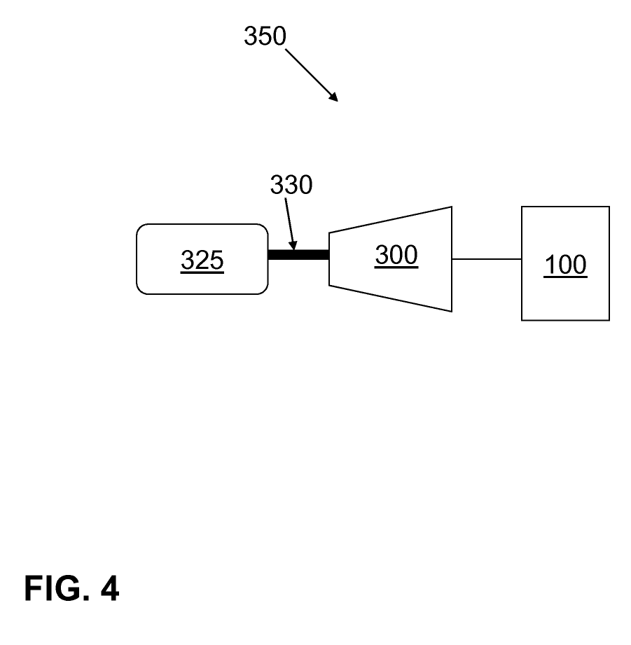

As indicated above, aspects of the invention provide for a filter assembly for filtering particles for a machine, such as machine 300 (FIG. 4), benefiting from improved air quality, e.g. clean, filtered air. It is understood that the embodiments of the invention may be applied to any machine that benefits from improved air quality. For example, the embodiments of the invention may be similarly applied to machines such as, but not limited to, gas, steam, or wind turbines.

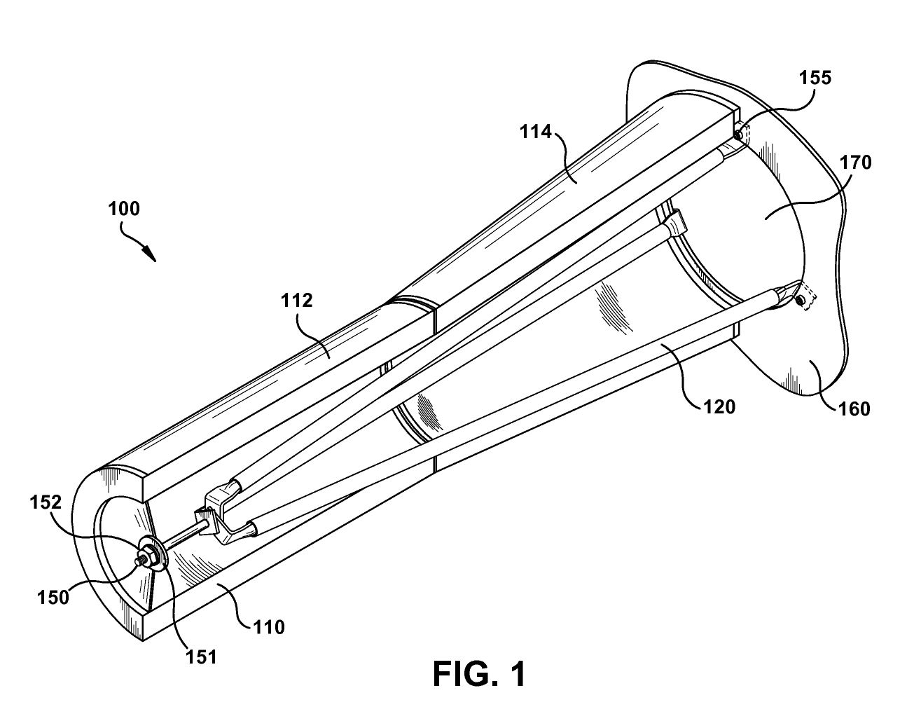

Turning to the figures, FIG. 1 shows a perspective view of a filter assembly 100 according to an embodiment of the invention. Filter assembly 100 may include at least one airflow inlet 170 in a plenum wall 160. Filter assembly 100 may also include at least one tubular filter element 110 adjacent to at least one airflow inlet 170 and a support member 120. Support member 120 may be attached to at least one tubular filter element 110 at a first portion 150 of support member 120 and a second portion 155 of support member 120. At first portion 150 and second portion 155, support member 120 may be attached to at least one tubular filter element 110 according to any now known or later developed manner. For example, as shown in FIG. 1, support member 120 may be attached to at least one tubular filter element 110 at first portion 150 by a washer 151 and a nut 152. Although not shown, support member 120 may be attached to at least one tubular filter element 110 at second portion 155 by a mechanical connection between filter element 110 and plenum wall 160. For example, a twist lock or flange configuration may be provided. At least one tubular filter element 110 may be configured to circumferentially surround support member 120.

According to an embodiment of the invention, support member 120 may comprise a composite material, which may include at least one polymer and at least one reinforcing agent. The composite material for support member 120 may comprise approximately 60% to approximately 95% polymer and approximately 5% to approximately 40% reinforcing agent. The polymer material may include any now known or later developed polymer, such as, but not limited to polypropylene, polyethylene, nylon, polyester, polyurethane, polyamides, polystyrene, polycarbonate, epoxy, or a blend of two of more of these polymers. The at least one reinforcing agent may include any now known or later developed reinforcing agent, such as, but not limited to glass fibers, carbon fibers, natural fibers, and fillers, such as calcium carbonate, talc or the like, or nanomaterials. Given that support member 120 may comprise a composite material, instead of conventional steel, the cost of support member 120 may be reduced, as well as the need for a replacement since the composite material will not corrode as quickly as steel. The weight of support member 120 may also be reduced, while increasing the lifetime of support member 120.

Composite material for support member 120 may be configured to meet all structural requirements for support member 120 of filter assembly 100. For example, composite material of support member 120 may withstand the operating temperature range of approximately −25 degrees Fahrenheit (F) to approximately 125 degrees F.

Composite material of support member 120 may also withstand the weight of dust-laden filter elements that is greater than approximately 100 pound-force (lbf). Further, since composite material of support member 120 may not corrode as quickly as steel, support member 120 will meet an expected life of at least approximately 30 years. This is an increase in lifespan as compared to a conventional steel support member, which most likely will corrode prior to 30 years, especially if placed in a location with moist or humid salt-laden air.

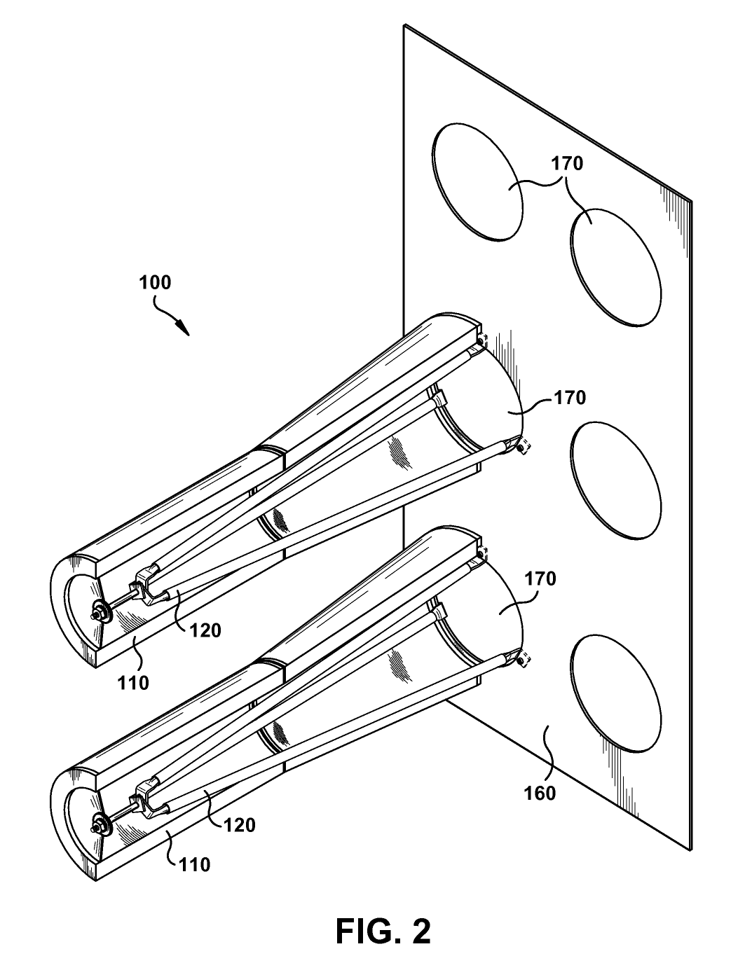

FIG. 1 shows filter assembly 100 including a single tubular filter element 110. However, filter assembly 100 may include a plurality of tubular filter elements 110, depending on the requirements of the system downstream of the filter assembly 100. As shown in FIG. 2, there may be additional airflow inlets 170 in plenum wall 160 and tubular filter element 110 may be adjacent to each airflow inlet 170.

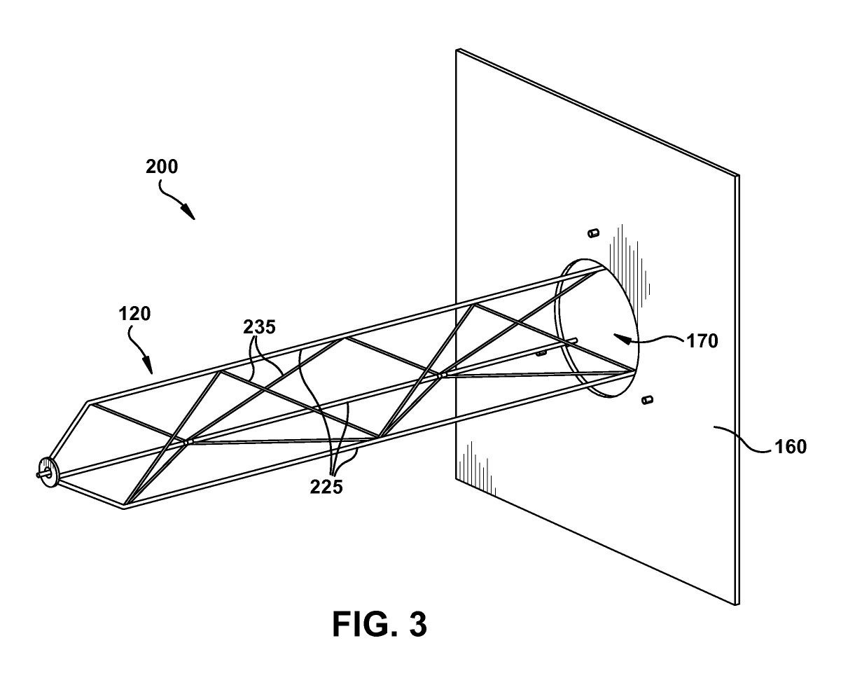

Referring now to FIGS. 1 and 2, support member 120 may include a tripod. The tripod of support member 120 may include three beams that may be connected at one end. In this embodiment, at least one filter element 110 may include at least one cylindrical filter cartridge 112. At least one cylindrical filter cartridge 112 may be connected to at least one conical filter cartridge 114. However, support member 120 may be formed in any other formation other than a tripod. For example, in the embodiment of filter assembly 200 shown in FIG. 3, support member 220 may include a plurality of beams 225 connected by a plurality of trusses 235.

Support member 120, 220 may be formed by any now known or later developed method, including, but not limited to, injection molding, thermoforming, extrusion, reaction injection molding (RIM), structural reaction injection molding

(SRIM), or sheet molded compounds (SMC).

Turning now to FIG. 4, a schematic view of a system 350 according to an embodiment of the invention is shown. System 350 may include a gas turbine 300. However, as mentioned above, the embodiments of the invention may be applied to any machine that benefits from improved air quality. For example, the embodiments of the invention may be similarly applied to different machines such as, but not limited to, gas, steam, or wind turbines. System 350 may also include filter assembly 100 (or filter assembly 200, as discussed herein) that is operably connected to gas turbine 300. Gas turbine 300 may be operably connected to a first load device 325. Load device 325 may include, for example, a conventional electric generator, a compressor, a pump, or any other conventional load device. Load device 325 and gas turbine 300 may be mechanically coupled by a shaft 330, which may transfer energy between a drive shaft (not shown) of gas turbine 300 and load device 325.

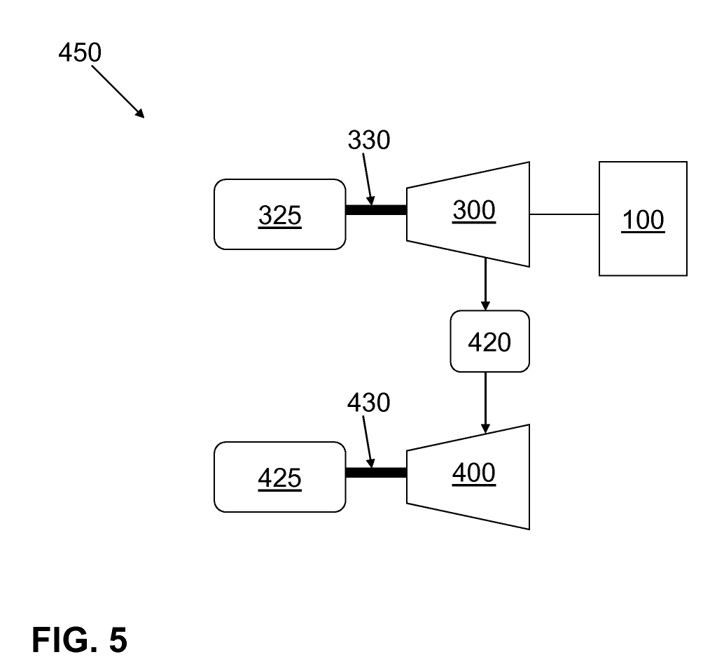

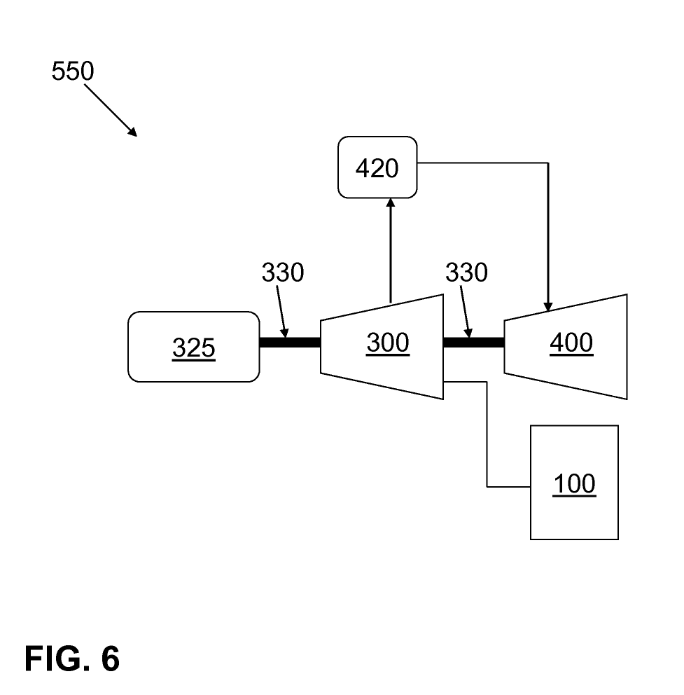

Turning to FIG. 5, a schematic view of portions of a multi-shaft combined cycle power plant 450 is shown. Combined cycle power plant 450 may include, for example, gas turbine 300 operably connected to first load device 325. Also shown in FIG. 5 is a heat exchanger 420 operably connected to gas turbine 300 and a steam turbine 400. System 450 may include filter assembly 100 (or filter assembly 200, as discussed herein). Heat exchanger 420 may be fluidly connected to both gas turbine 300 and steam turbine 400 via conventional conduits (numbering omitted). Heat exchanger 420 may be a conventional heat recovery steam generator (HRSG), such as those used in conventional combined cycle power systems. As is known in the art of power generation, HRSG may use hot exhaust from gas turbine 300, combined with a water supply, to create steam which is fed to steam turbine 400. Steam turbine 400 may optionally be coupled to a second load device 425 (via a second shaft 430). Second load device 425 and second shaft 430 may operate substantially similarly to load device 325 and shaft 330 described above. In another embodiment, shown in FIG. 6, a single shaft combined cycle power plant 550 may include a single generator 325 coupled to both gas turbine 300 and steam turbine 400 via a single shaft 330.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

This written description uses examples to disclose the various embodiments of the present invention, including the best mode, and also to enable any person skilled in the art to practice the invention, including making and using any devices or systems and performing any incorporated methods. The patentable scope of the various embodiments of the present invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A filter assembly comprising:
at least one airflow inlet;
at least one tubular filter element adjacent to the at least one airflow inlet; and
a support member attached to the at least one tubular filter element at a first portion and a second portion of the support member, the at least one tubular filter element circumferentially surrounding the support member, wherein the support member comprises a composite material.

2. The filter assembly of claim 1, wherein the composite material comprises at least one polymer and at least one reinforcing agent.

3. The filter assembly of claim 2, wherein the at least one polymer comprises approximately 60% to approximately 95% of the composite material.

4. The filter assembly of claim 2, wherein the at least one polymer comprises at least one of the following: polypropylene, polyethylene, nylon, polyester, polyurethane, polyamides, polystyrene, polycarbonate, and epoxy.

5. The filter assembly of claim 2, wherein the at least one reinforcing agent comprises approximately 5% to approximately 40% of the composite material.

6. The filter assembly of claim 2, wherein the at least one reinforcing agent comprises at least one of the following: glass fibers, carbon fibers, natural fibers, calcium carbonate, talc, or a nanomaterial.

7. The filter assembly of claim 1, wherein the support member is a tripod.

8. The filter assembly of claim 1, wherein the support member includes a plurality of beams connected by a plurality of trusses.

9. A system comprising:
a gas turbine; and
a filter assembly operably connected to the gas turbine, the filter assembly comprising:
at least one airflow inlet;
at least one tubular filter element adjacent to the at least one airflow inlet; and
a support member attached to the at least one tubular filter element at a first portion and a second portion of the support member, the at least one tubular filter element circumferentially surrounding the support member, wherein the support member comprises a composite material.

10. The system of claim 9, wherein the composite material comprises at least one polymer and at least one reinforcing agent.

11. The system of claim 10, wherein the at least one polymer comprises approximately 60% to approximately 95% of the composite material.

12. The system of claim 10, wherein the at least one polymer comprises at least one of the following: polypropylene, polyethylene, nylon, polyester, polyurethane, polyamides, polystyrene, polycarbonate, and epoxy.

13. The system of claim 10, wherein the at least one reinforcing agent comprises approximately 5% to approximately 40% of the composite material.

14. The system of claim 10, wherein the at least one reinforcing agent comprises at least one of the following: glass fibers, carbon fibers, natural fibers, calcium carbonate, talc, or a nanomaterial.

15. The system of claim 9, wherein the support member is a tripod.

16. The machine of claim 9, wherein the support member includes a plurality of beams connected by a plurality of trusses.

17. A system comprising:
a gas turbine;
a heat exchanger operably connected to the gas turbine;
a steam turbine operably connected to the heat exchanger; and
a filter assembly operably connected to the gas turbine, the filter assembly comprising:
at least one airflow inlet;
at least one tubular filter element adjacent to the at least one airflow inlet; and
a support member attached to the at least one tubular filter element at a first portion and a second portion of the support member, the at least one tubular filter element circumferentially surrounding the support member, wherein the support member comprises a composite material.

18. The system of claim 17, wherein the composite material comprises at least one polymer and at least one reinforcing agent, wherein the at least one polymer comprises approximately 60% to approximately 95% of the composite material and the at least one reinforcing agent comprises approximately 5% to approximately 40% of the composite material.

19. The system of claim 18, wherein the at least one polymer comprises at least one of the following: polypropylene, polyethylene, nylon, polyester, polyurethane, polyamides, polystyrene, polycarbonate, and epoxy.

20. The system of claim 18, wherein the at least one reinforcing agent comprises at least one of the following: glass fibers, carbon fibers, natural fibers, calcium carbonate, talc, or a nanomaterial.
